(19) United States
(12) Patent Application Publication
(10) Pub. No.: US 2023/0141632 A1
(43) Pub. Date: May 11, 2023

(54) SYSTEMS AND METHODS FOR OPTIMIZING GAMEPLAY ON AN ELECTRONIC SOCIAL GAMING PLATFORM

(71) Applicant: Unicorn 7 Inc., Plano, TX (US)

(72) Inventors: Levan Owens, Plano, TX (US); Onome Ufomata, Cedar Park, TX (US)

(21) Appl. No.: 17/983,160

(22) Filed: Nov. 8, 2022

Related U.S. Application Data
(60) Provisional application No. 63/276,732, filed on Nov. 8, 2021.

(51) Int. Cl. A63F 13/828; A63F 13/79

(52) U.S. Cl. CPC A63F 13/828; A63F 13/79; A63F 2300/8052; A63F 2300/5546

(57) ABSTRACT

The present invention is related to an electronic social gaming platform for applications such as fantasy sports. The invention comprises a unique approach to optimize gameplay aspects to maintain a competitive balance as the number of registered, active users changes over time. Through the inventive concepts disclosed herein, gameplay can be optimized as a function of season progress such that a competitive balance is maintained throughout the duration of the season.

### CROSS-REFERENCE TO RELATED APPLICATIONS

This application claims the benefit of U.S. Provisional Application 63/276,732, filed Nov. 8, 2021, titled “SYSTEMS AND METHODS FOR DYNAMICALLY DETERMINING PLAYER VALUES FOR FANTASY SPORTS APPLICATIONS,” which is herein incorporated by reference in its entirety.

### BACKGROUND

In traditional fantasy sports, the number of users participating in a league is critical to ensuring an enjoyable balance of talent across the teams in a league. This is due in part to how traditional fantasy sports allocate players to teams within a league such that no two teams can roster the same player, or stated another way, that each player may be rostered by only a single team in that league. The talent pool for a given sport and roster requirements of a given league, result in an optimal number (or relatively small range) of league participants to achieve an enjoyable competitive balance. Too few teams in a league can lead to every team having stellar players at all roster positions with potentially more stellar players unrostered, while too many teams in a league leads to a dilution of talent and teams rostering players who produce little or no fantasy points. Furthermore, given the limited talent pool for a given sport, especially with larger league sizes, it is difficult for users to make roster changes throughout a season in order to add quality players when necessary such as when a rostered player is injured or otherwise unavailable to participate in upcoming events, when a player is on a bye week, etc. Because of the scarcity of quality talent in a given sport, events such as injuries to a user's rostered players can effectively ruin a user's participation and enjoyment of a fantasy season because they are unable to replace an injured star/quality player with a productive, quality alternative in order to keep their team competitive with other users. Ultimately, large communities of participants are unable to participate together in traditional fantasy sports, while smaller groups of participants may be forced to recruit additional players in order to achieve a competitive balance.

Fantasy sports participants may often participate or desire to participate in multiple leagues, such as one with friends, one with family, one with work colleagues, etc. For each league an individual participates in, traditional fantasy sports require drafting a respective team for that league in accordance with each leagues roster requirements. While some may enjoy the draft experience, for others it is not practical nor enjoyable to endure a plurality of drafts, thus limiting participation of some individuals to one or a smaller number of leagues than desired. Furthermore, the upkeep (e.g. setting a daily or weekly starting roster, making roster adjustments associated with bye weeks, injuries, player performance) associated with several different rosters in different leagues can be overwhelming thus taking away from enjoyment of the fantasy sports experience.

There is currently no known season-long fantasy sports platform which allows multiple users in the same league to roster the same player, provides a talent pool structure to accommodate leagues of any size, allows a user to participate in multiple leagues with a single roster, and which provides system wide balancing measures to influence and control player ownership.

### SUMMARY

The present invention overcomes these limitations by providing a fantasy sports platform or components for use in a fantasy sports platform which allow for fantasy sports participation that is not dependent on league sizes to ensure competitive balance and allows users to participate in multiple leagues with different groups of other users while maintaining a single roster. This is accomplished through a virtual currency and dynamic player value based approach which establishes initial rosters based on virtual currency, computes and adjusts player values in real-time based on player demand/popularity metrics and player performance metrics such as fantasy points produced, and controls changes to rosters based on virtual currency balance and the real-time player values. The systems and methods described herein dynamically adjust player values in real-time based on various factors such as the number of times a given player is added or removed from a roster, the rate at which a given player is added or removed from a roster, past and projected player performance, etc. By controlling player values in accordance with demand, a balance of player ownership can be implemented system wide since increasing player values will make it more difficult to acquire that player. In order to acquire a high value player, a user will be required to satisfy virtual currency requirements which may involve selling or dropping another player or players in order to have the purchasing power needed for the high value player. In a sense, the player values fluctuate in a similar fashion to stocks in the stock market as market demand changes or as company performance changes.

### BRIEF DESCRIPTION OF THE DRAWINGS

The accompanying drawings illustrate several embodiments and, together with the description, serve to explain the principles of the invention according to the embodiments. It will be appreciated by one skilled in the art that the particular arrangements illustrated in the drawings are merely exemplary and are not to be considered as limiting of the scope of the invention or the claims herein in any way.

FIG. 1 illustrates a fantasy sports system in accordance with an exemplary embodiment of the invention.

FIG. 2 illustrates a player exchange engine for use in fantasy sports in accordance with an exemplary embodiment of the present invention.

FIG. 3A illustrates an exemplary process for computing and updating player values based on real-time metrics according to one embodiment of the invention.

FIG. 3B illustrates an exemplary process for updating player values in accordance with roster changes according to one embodiment of the invention.

FIG. 4 illustrates one embodiment of the computing architecture that supports an embodiment of the inventive disclosure.

FIG. 5 illustrates components of a system architecture that supports an embodiment of the inventive disclosure.

FIG. 6 illustrates components of a computing device that supports an embodiment of the inventive disclosure.

FIG. 7 illustrates components of a computing device that supports an embodiment of the inventive disclosure.

### DETAILED DESCRIPTION

One or more different embodiments may be described in the present application. Further, for one or more of the embodiments described herein, numerous alternative arrangements may be described; it should be appreciated that these are presented for illustrative purposes only and are not limiting of the embodiments contained herein or the claims presented herein in any way. One or more of the arrangements may be widely applicable to numerous embodiments, as may be readily apparent from the disclosure. In general, arrangements are described in sufficient detail to enable those skilled in the art to practice one or more of the embodiments, and it should be appreciated that other arrangements may be utilized and that structural, logical, software, electrical and other changes may be made without departing from the scope of the embodiments. Particular features of one or more of the embodiments described herein may be described with reference to one or more particular embodiments or figures that form a part of the present disclosure, and in which are shown, by way of illustration, specific arrangements of one or more of the aspects. It should be appreciated, however, that such features are not limited to usage in the one or more particular embodiments or figures with reference to which they are described. The present disclosure is neither a literal description of all arrangements of one or more of the embodiments nor a listing of features of one or more of the embodiments that must be present in all arrangements.

Headings of sections provided in this patent application and the title of this patent application are for convenience only and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible embodiments and in order to more fully illustrate one or more embodiments. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the embodiments, and does not imply that the illustrated process is preferred. Also, steps are generally described once per aspect, but this does not mean they must occur once, or that they may only occur once each time a process, method, or algorithm is carried out or executed. Some steps may be omitted in some embodiments or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various embodiments in which, for example, functions may be executed out of order from that shown or discussed, including substantially concurrently or in reverse order, depending on the functionality involved, as would be understood by those having ordinary skill in the art.

The detailed description set forth herein in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

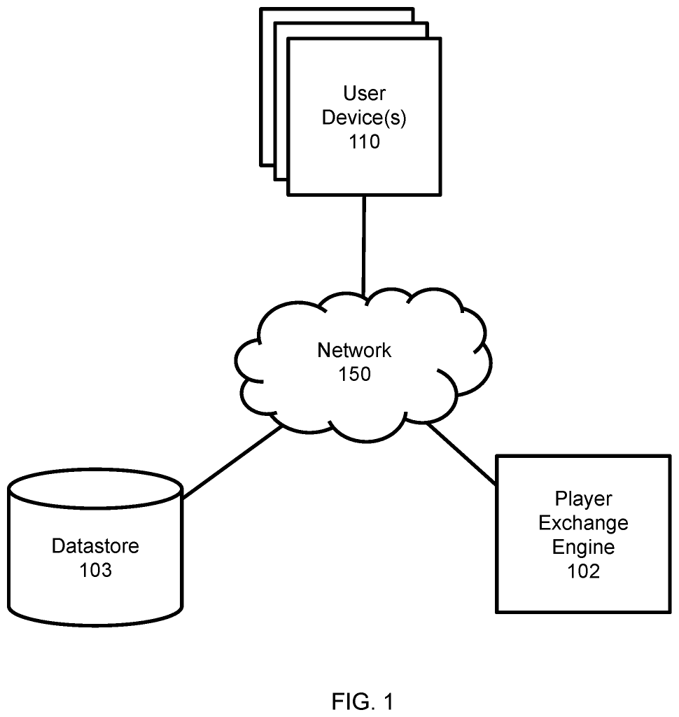

FIG. 1 illustrates an exemplary embodiment of a system 100 for fantasy sports applications according to one embodiment. The system 100 comprises user device(s) 101, player exchange engine 102, datastore(s) 103, and a network 150 over which the various systems communicate and interact. The various computing devices described herein are exemplary and for illustration purposes only. The system may be reorganized or consolidated, as understood by a person of ordinary skill in the art, to perform the same tasks on one or more other servers or computing devices without departing from the scope of the invention.

User device(s) 110 are operable to receive input from a user regarding fantasy sports related actions, obtain information from a player exchange engine 102 and/or a fantasy sports platform, obtain fantasy sports related information from datastore(s) 103, and display fantasy sports related information to a user. In one aspect, user device(s) 110 interacts with player exchange engine 102 in order to create and/or modify a user's roster for a given fantasy sport in which the user is participating.

User device(s) 110 include, generally, a computer or computing device including functionality for communicating (e.g., remotely) over a network 150. Data may be collected from user devices 110, and data requests may be initiated from each user device 110. User device(s) 110 may be a server, a desktop computer, a laptop computer, personal digital assistant (PDA), an in- or out-of-car navigation system, a smart phone or other cellular or mobile phone, or mobile gaming device, among other suitable computing devices. User devices 110 may execute one or more client applications, such as a web browser (e.g., Microsoft Windows Internet Explorer, Mozilla Firefox, Apple Safari, Google Chrome, and Opera, etc.), or a dedicated application to submit user data, or to make prediction queries over a network 150.

In particular embodiments, each user device 110 may be an electronic device including hardware, software, or embedded logic components or a combination of two or more such components and capable of carrying out the appropriate functions implemented or supported by the user device 110. For example and without limitation, a user device 110 may be a desktop computer system, a notebook computer system, a netbook computer system, a handheld electronic device, or a mobile telephone. The present disclosure contemplates any user device 110. A user device 110 may enable a network user at the user device 110 to access network 150. A user device 110 may enable its user to communicate with other users at other user devices 110.

A user device 110 may have a web browser, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user device 110 may enable a user to enter a Uniform Resource Locator (URL) or other address directing the web browser to a server, and the web browser may generate a Hyper Text Transfer Protocol (HTTP) request and communicate the HTTP request to server. The server may accept the HTTP request and communicate to the user device 110 one or more Hyper Text Markup Language (HTML) files responsive to the HTTP request. The user device 110 may render a web page based on the HTML files from server for presentation to the user. The present disclosure contemplates any suitable web page files. As an example and not by way of limitation, web pages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a web page encompasses one or more corresponding web page files (which a browser may use to render the web page) and vice versa, where appropriate.

The user device 110 may also include an application that is loaded onto the user device 110. The application obtains data from the network 150 and displays it to the user within the application interface.

Exemplary user devices are illustrated in some of the subsequent figures provided herein. This disclosure contemplates any suitable number of user devices, including computing systems taking any suitable physical form. As example and not by way of limitation, computing systems may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, the computing system may include one or more computer systems; be unitary or distributed; span multiple locations; span multiple machines; or reside in a cloud, which may include one or more cloud components in one or more networks. Where appropriate, one or more computing systems may perform without substantial spatial or temporal limitation one or more steps of one or more methods described or illustrated herein. As an example, and not by way of limitation, one or more computing systems may perform in real time or in batch mode one or more steps of one or more methods described or illustrated herein. One or more computing system may perform at different times or at different locations one or more steps of one or more methods described or illustrated herein, where appropriate.

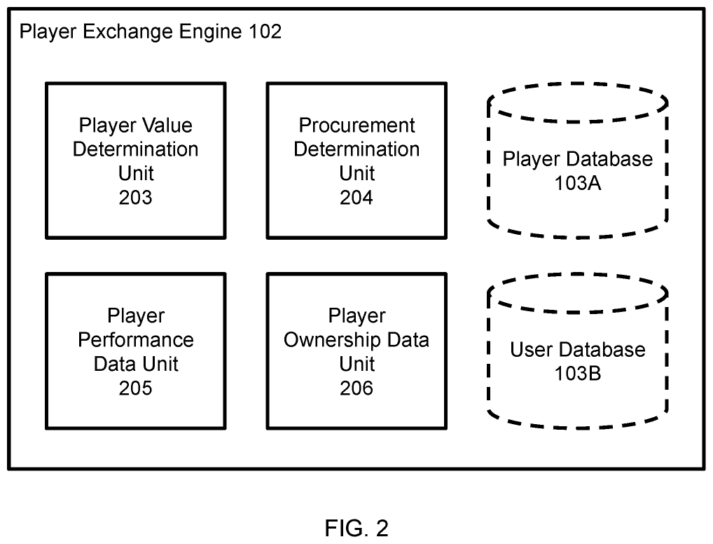

Player exchange engine 102 is operable to obtain fantasy sports related information from at least one of user device(s) 110 and datastore 103, compute player values associated with at least one fantasy sport, compute procurement capability values associated with at least one user, and output computed results to at least one of user device(s) 110 and datastore 103. In one aspect, player exchange engine 102 may be a fantasy sports platform operable to perform additional functions associated with fantasy sports data management and output. In one aspect, player exchange engine 102 may be part of (such as a sub component of) a fantasy sport platform. In one aspect, player exchange engine 102 may be a distinct component operable to communicate with a fantasy sports platform. The player exchange engine 102 is described in detail below with respect to FIG. 2.

Datastore(s) 103 comprises at least one medium for receiving, storing, and providing relevant data associated with fantasy sports applications. In one aspect, the datastore(s) 103 stores information associated with user's participating in at least one fantasy sport, at least one roster associated with each user, user procurement capability values for each fantasy sport in which the user is participating, player values associated with each fantasy sport, and player metrics associated with each fantasy sport such as player ownership/demand metrics and player performance/status metrics. Although depicted as a separate component, datastore(s) 103 may be incorporated into other components of the system such as player exchange engine 102, user device(s) 110 and/or a separate fantasy sports platform.

Network cloud 150 generally represents a network or collection of networks (such as the Internet or a corporate intranet, or a combination of both) over which the various components illustrated in FIG. 1 (including other components that may be necessary to execute the system described herein, as would be readily understood to a person of ordinary skill in the art). In particular embodiments, network 150 is an intranet, an extranet, a virtual private network (VPN), a local area network (LAN), a wireless LAN (WLAN), a wide area network (WAN), a metropolitan area network (MAN), a portion of the Internet, or another network 150 or a combination of two or more such networks 150. One or more links connect the systems and databases described herein to the network 150. In particular embodiments, one or more links each includes one or more wired, wireless, or optical links. In particular embodiments, one or more links each includes an intranet, an extranet, a VPN, a LAN, a WLAN, a WAN, a MAN, a portion of the Internet, or another link or a combination of two or more such links. The present disclosure contemplates any suitable network 150, and any suitable link for connecting the various systems and databases described herein.

The network 150 connects the various systems and computing devices described or referenced herein. In particular embodiments, network 150 is an intranet, an extranet, a virtual private network (VPN), a local area network (LAN), a wireless LAN (WLAN), a wide area network (WAN), a metropolitan area network (MAN), a portion of the Internet, or another network 421 or a combination of two or more such networks 150. The present disclosure contemplates any suitable network 150.

One or more links couple one or more systems, engines or devices to the network 150. In particular embodiments, one or more links each includes one or more wired, wireless, or optical links. In particular embodiments, one or more links each includes an intranet, an extranet, a VPN, a LAN, a WLAN, a WAN, a MAN, a portion of the Internet, or another link or a combination of two or more such links. The present disclosure contemplates any suitable links coupling one or more systems, engines or devices to the network 150.

In particular embodiments, each system or engine may be a unitary server or may be a distributed server spanning multiple computers or multiple datacenters. Systems, engines, or modules may be of various types, such as, for example and without limitation, web server, news server, mail server, message server, advertising server, file server, application server, exchange server, database server, or proxy server. In particular embodiments, each system, engine or module may include hardware, software, or embedded logic components or a combination of two or more such components for carrying out the appropriate functionalities implemented or supported by their respective servers. For example, a web server is generally capable of hosting websites containing web pages or particular elements of web pages. More specifically, a web server may host HTML files or other file types, or may dynamically create or constitute files upon a request, and communicate them to clients devices or other devices in response to HTTP or other requests from clients devices or other devices. A mail server is generally capable of providing electronic mail services to various clients devices or other devices. A database server is generally capable of providing an interface for managing data stored in one or more data stores.

In particular embodiments, one or more data storages may be communicatively linked to one or more servers via one or more links. In particular embodiments, data storages may be used to store various types of information. In particular embodiments, the information stored in data storages may be organized according to specific data structures. In particular embodiments, each data storage may be a relational database. Particular embodiments may provide interfaces that enable servers or clients to manage, e.g., retrieve, modify, add, or delete, the information stored in data storage.

The system may also contain other subsystems and databases, which are not illustrated in FIG. 1, but would be readily apparent to a person of ordinary skill in the art. For example, the system may include databases for storing data, storing features, storing outcomes (training sets), and storing models. Other databases and systems may be added or subtracted, as would be readily understood by a person of ordinary skill in the art, without departing from the scope of the invention.

FIG. 2 illustrates an exemplary embodiment of the player exchange engine 102. The player exchange engine 102 computes player values and controls roster changes (e.g. adding/removing players) based on the computed player values. The player exchange engine 102 comprises player value determination unit 203, procurement determination unit 204, player performance data unit 205, player ownership data unit 207, and optionally player database 103A and user database 103B. Other systems and databases may be used, as would be readily understood by a person of ordinary skill in the art, without departing from the scope of the invention.

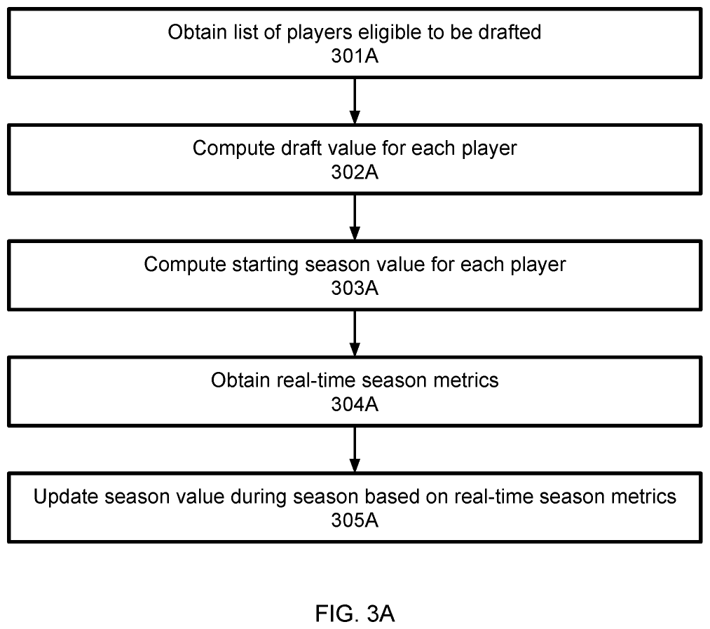

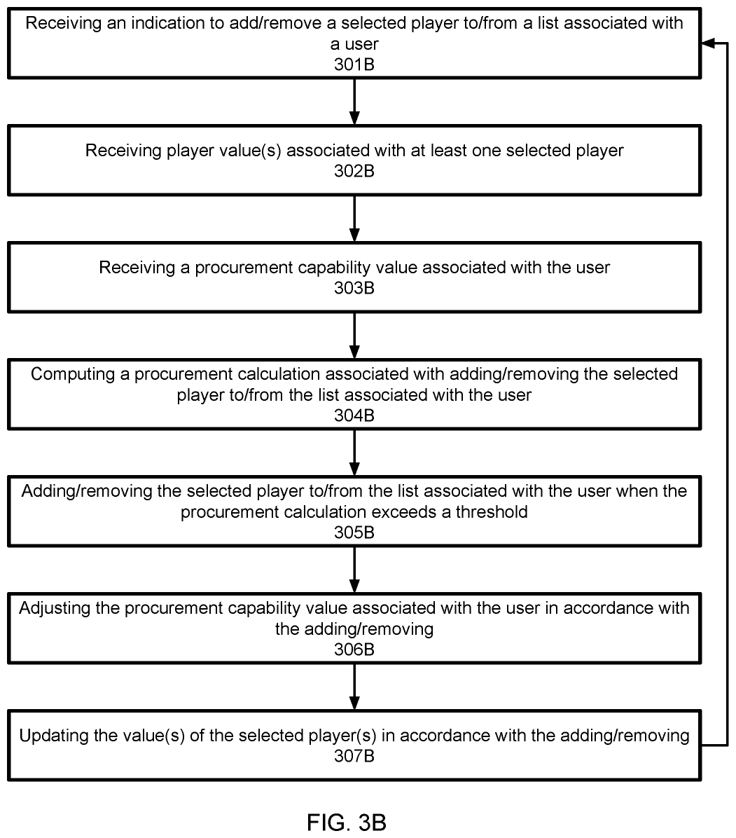

Player value determination unit 203 determines player values at various time points such as prior to or at the start of a draft time period, during a draft time period, at the end of a draft time period, prior to or at the start of a season and/or during a season. Player value determination unit 203 computes player values for players of a given sport based on a number of different considerations including at least one of player ownership/demand metrics and player performance/status metrics which may be obtained from player ownership data unit 206 and player performance data unit 205. In one aspect, player value determination unit 203 computes player values in real-time as a draft or season progresses thereby reflecting updated real-time changes in fantasy market value or fantasy demand. In one aspect, player ownership/demand metrics and player performance/status metrics are combined to determine player value. In general, player value determination unit 203 will compute or adjust player values to increase as player ownership/demand increases and/or as player performance/status improves and decrease as player ownership/demand decreases and/or as player performance/status declines. The rate at which a player's value increases or decreases may be controlled as a function of the rate of change in the player ownership/demand and/or player performance/status metrics. In one aspect, player value determination unit 203 is configured to compute player values using different metrics or variables for different sports. The discussion below associated with FIGS. 3A-3B provide additional detail of some exemplary player value calculations which may be performed.

Procurement determination unit 204 performs calculations associated with adding and removing players from a user's roster and adjusts a procurement value associated with each user in accordance with the adding and removing of players from the user's roster. In one aspect, the procurement value is a virtual currency balance which may be established at the start of a draft, used to acquire players during a draft time period, and used to acquire players throughout a season. Procurement determination unit 204 computes whether a procurement value associated with a user will fall below or remain above a threshold (e.g. zero) in association with any proposed roster changes such as adding/removing at least one player from a user's roster. In this way, a user is limited to exchanging players only in circumstances where the outcome of the player exchange results in the user maintaining a positive procurement value (e.g. virtual currency balance). The discussion below associated with FIGS. 3A-3B provide additional detail of some exemplary procurement calculations which may be performed.

Player performance data unit 205 obtains player performance data and computes player performance metrics. In one aspect, player performance data unit 205 computes past player performance metrics such as statistical totals and/or converts player statistics into fantasy points. Player performance data unit 205 may compute trends in player performance such as whether fantasy points have been increasing, decreasing, remaining consistent, or have no discernable or relevant pattern. In one aspect, player performance data unit 205 computes metrics weighted based on difficulty of past or upcoming opponents. In one aspect, player performance data unit 205 computes projected performance metrics such as projected statistics or projected fantasy points based on at least one of past performance information and upcoming matchup information. In one aspect, player performance data unit 205 obtains player status information such as health or injury status, whether the player is a starter or backup, etc. and factors this information into projected performance metrics. Additional discussion of player performance metrics is presented below in association with FIG. 3A-3B.

In one aspect, player exchange unit 102 uses player performance metrics computed from player performance data unit 205, to rank users and assign position points to each user based on the user's rank. For example, for a given period (e.g. a week, one or more events/games, etc), fantasy points from player performance data unit 205 are determined for each player on a user's starting roster in order to compute a fantasy points total for each user for the given period. All users are then ranked based on their total fantasy points for the period and assigned a corresponding amount of position points. In one aspect position points may be assigned based on ranking percentile, such as 90th percentile or higher (i.e. the top 10%) receiving 25 points, 75th percentile or higher receiving 10 points, 50th percentile or higher receiving 5 points, and so on. It is noted that the percentile divisions and number of position points assigned is merely exemplary and different percentiles and corresponding position point values can be used without diverging from the scope of the invention. A fantasy season may comprise a plurality of such periods (e.g. multiple competition weeks, multiple games, etc.) and this ranking and position points allocation may be performed independently for each period along with computing a cumulative, running total throughout the duration of the season in order to determine the overall best performers and/or determine users eligible to compete in a fantasy season playoff competition.

Player ownership data unit 207 obtains information associated with player ownership and computes player demand metrics. In one aspect player ownership information comprises ownership percentage, add/drop occurrences, rate at which adds/drops are occurring for a given player, rate at which add/drops are occurring for a given player compared to a position based average for that player's position, etc. In one aspect, player demand metrics comprise computing from the above player ownership information if player demand is changing and the rate at which the demand is changing.

Player database 103A stores player data associated with at least one sport. Player data comprises at least one of lists of players in association with a given sport, player values, player position information, player team, player ownership/demand information, and player performance/status information.

User database 103B stores user data associated with at least one sport. User data comprises at least one of a user's roster for each fantasy sport in which a user is participating and user procurement capability value for each roster/sport.

Player database 103A and user database 103B may be incorporated into the player exchange engine 102 or may be separate datastore components accessed via a network such as depicted in FIG. 1 above.

FIG. 3A illustrates an exemplary process for computing and updating player values based on real-time metrics. The process comprises obtaining at least one list of players eligible to be drafted 301A, computing a draft value for each player 302A, computing a starting season value for each player 303A, obtaining real-time season metrics 304A, and updating the season value for each player during a season based on real-time season metrics 305A.

At step 301A, the process comprises obtaining at least one list of players eligible to be drafted. This list of players may be determined based on a number of considerations including at least one of, but not limited to, sport/event, position, current roster status (e.g. on a team roster, free agent, etc.), past season(s) performance, past season(s) fantasy performance, past season(s) fantasy ownership information

At step 302A, the process comprises computing a draft value for each player in the list of players eligible to be drafted. Computing comprises computing a starting draft value associated with a draft time period. In one aspect, computing draft values comprises updating draft values throughout the draft time period based on real-time ongoing draft statistics across a plurality of users. In one aspect, computing draft values comprises updating draft values throughout the draft time period based on real-time player status information, such as preseason performance, injury status, changes in the player's associated team depth chart (e.g. player changed from a starter to a backup player or vice versa, team acquisition of a new player at the same position, player traded, released, cut, or demoted, etc.), and player draft metrics such as number of times drafted, draft frequency (how often a player is drafted in a given time), ownership percentage, draft position/order (e.g. early draft pick vs late draft pick), draft position/order by player position (e.g. order a running back was drafted compared to other running backs, order a wide receiver was drafted compared to other wide receivers, etc.).

At step 303A, the process comprises computing a starting season value for each player. The starting season value for each player may be the same as the starting draft value, the updated player draft value at the end of the draft time period, or calculated according to one or more of the variables listed above with respect to computing and updating draft value in step 302A. In one aspect, the starting season value may be computed using a weighting algorithm that applies equal or different weights to one or more of the above listed variables. In one aspect, the starting season value may be computed in a more granular fashion than draft values. For example, draft values may be computed as whole numbers reflecting a more general draft value, while season values may be computed with decimal values providing an added degree of specificity with respect to value in order to better differentiate and distinguish player values from each other as the above listed information and metrics change. In one aspect, a sport may not have a traditional season, per se, but instead comprises one or more events or competitions. In these scenarios, the starting season value would comprise a starting player value before the event or competition, while in-season values, as discussed later, would be values associated with the ongoing event(s) or competition(s).

At step 304A, the process comprises obtaining real-time season metrics. The season metrics comprise at least one of number of add/drop occurrences for each player including recent and season long measures, the frequency or rate at which a player is added/dropped including recent and season long measures, player performance metrics such as sport relevant statistics such as season totals to date, recent game(s)/event(s) statistics, projected statistics for upcoming game(s)/event(s), and fantasy points computed from sport relevant statistics such as total fantasy points, fantasy points per game/event.

At step 305A, the process comprises updating the season value for each player during a season based on real-time season metrics. Updating the season value comprises computing a current or updated season value based on at least one of the above mentioned obtained real-time season metrics. In one aspect, the updated season values are computed at threshold intervals (e.g. hourly, daily, weekly, after a certain number of add/drop transactions for a given player or across all players, etc.). For example, a given player's current value may be updated each time that player is added or removed from (also referred to as dropped) a roster. In addition or alternatively, a given player's current value may be updated after a threshold number of transactions associated with that player such as after 25, 50, 100, 1000, etc. transactions. In addition or alternatively, all player values may be updated after a threshold number of system-wide transactions for a given sport involving any player such as after 25, 50, 100, 1000, etc. transactions across the entire network of users/rosters for a given sport.

In one aspect each player's current value is updated based on the number of times that player has been added or dropped. In one aspect, if the number of times that player has been added is greater than the number of times that player has been dropped then the player value will increase. Conversely, if the number of times that player has been dropped is greater than the number of times that player has been added then the player value will decrease. The magnitude of the increase or decrease may be linearly or nonlinearly related to the numerical difference between the number of adds and drops associated with that player. The number of add/drop occurrences to use in computing an updated player value may comprise all occurrences for the duration of the season or may comprise a shorter time span such as over the most recent days or week(s). In one aspect, the number of times a player is added or dropped may be considered in light of the time frame over which the adds and drops occurred in order to compute a frequency or rate at which the player is being added or dropped (this may also be referred to as the velocity at which a player is being added or dropped). In one aspect, the updated player value comprises accounting for the rate at which a player is added or dropped and similarly to the above, updated player value may be updated in such a way that the rate has a linear or nonlinear effect on player value.

In one aspect, current ownership percentage and the rate at which ownership changes may be used in calculating current or updated player values. This is similar to the above using occurrences and rates of adds/drops, however takes into account additional aspects such as player draft percentage or player ownership to start the season as opposed to more transaction based metrics occurring throughout a season. In one aspect, updated season values are stored in a database for later reference or computed in real-time as needed such as when a user initiates a process associated with adding or removing a player from their roster. For example, updated season values may be pulled from a database and/or computed in real-time when a user initiates a projected add/drop (e.g. initiates a query/preview of what their roster and virtual currency balance would be should they make a certain roster change).

In one aspect, computing an updated season values comprises a weighting algorithm where a plurality of the above listed variables or metrics (including those listed in association with steps 302A, 303A and 304A) are combined to determine a player's season value. Each variable may be given the same or different weights. For example, more recent performance or add/drop measures may be given a higher weight than older performance or add/drop measures. In one aspect, users may be aware of player performance and perform add/drops accordingly which will affect player value as discussed above. Therefore player performance may be given less weight in a weighting algorithm to account for this phenomenon.

FIG. 3B illustrates an exemplary process for updating player values in accordance with roster changes. The process comprises receiving an indication to add or remove at least one selected player to or from a list associated with a user 301B, receiving player values associated with the at least one selected player(s) 302B, receiving a procurement capability value associated with the user 303B, computing a procurement calculation associated with adding or removing the selected player(s) to or from the list associated with the user 304B, adding or removing the selected player(s) to or from the list associated with the user when the procurement calculation exceeds a threshold value 305B, adjusting the procurement capability value associated with the user in accordance with the executed adding or removing 306B, and updating the value(s) of the selected player(s) in accordance with the adding/removing 307B.

At step 301B, the process comprises receiving an indication to add or remove at least one selected player to or from a list associated with a user. In one aspect, the list associated with a user comprises a roster associated with a user for a particular fantasy sport in which the user is or will be competing. The indication may be received from a user such as a user initiating a roster change to at least one of add at least one player to their roster, remove at least one player from their roster or a combination of adding and removing player(s) to/from their roster.

At step 302B, the process comprises receiving player values associated with the at least one selected player(s). In one aspect, the player values are received from a player database storing at least player value information associated with players eligible to be added or removed from user rosters. In one aspect, the player values are computed or received from a system component or unit that computes the player values in real-time in response to step 301B. Player values may be computed as discussed with respect to FIG. 3A.

At step 303B, the process comprises receiving a procurement capability value associated with the user. In one aspect, the procurement capability value comprises a virtual currency balance representative of a user's purchasing power associated with adding/removing players to their roster. In one aspect, the procurement capability value is received from a user database storing at least information associated with a user's virtual currency balance.

At step 304B, the process comprises computing a procurement calculation associated with adding or removing the selected player to or from the list associated with the user. The procurement calculation comprises subtracting from the procurement capability value the value(s) of all the players selected to add to a user's roster and adding the value(s) of all players selected to remove from the user's roster. In the example of a virtual currency balance, this calculation would result in determining a new virtual currency balance resulting from the adding/removing of the at least one selected player.

At step 305B, the process comprises adding and/or removing the selected player(s) to or from the list associated with the user when the procurement calculation exceeds a threshold value. In one aspect, the threshold value is set to zero such that user's are prevented from executing adding/dropping actions that would result in negative virtual currency balances. In one aspect, if the procurement calculation exceeds the threshold value, a user may be prompted to confirm proceeding with the indicated adding/dropping which may comprise previewing the transaction and resulting procurement capability value or virtual currency balance prior to executing the adding/removing of the at least one selected player. In one aspect, if the procurement calculation is below the threshold value, a user may be notified that the adding/removing is unsatisfactory and not allowed and may optionally comprise prompting the user to modify the adding/removing in order to achieve a satisfactory result. For example, a user may be prompted to or otherwise modify the indication to remove an additional player in order to increase their procurement capability value or may be prompted to or otherwise modify the indication to add a different player which would result in the procurement calculation exceeding the threshold value.

At step 306B, the process comprises adjusting the procurement capability value associated with the user in accordance with the executed adding or removing. For example, when the indication to add/remove at least one selected player results in a positive (greater than zero) remaining procurement capability value and the adding/removing is performed, a user's procurement capability value is adjusted to match the result of the procurement calculation. The updated or adjusted procurement capability value may be stored in a user database for later reference for additional, future adding/removing of players.

At step 307B, the process comprises updating the value(s) of the selected player(s) in accordance with the adding/removing. In one aspect, updating comprises updating a player database that stores at least player values. In one aspect the player value(s) are updated in real-time as soon as the adding/removing of the selected player(s) is executed. In one aspect, updating comprises collecting a batch of adding/removing results before player value(s) is/are updated. In these scenarios, the adding/removing results may be stored in a database for later analysis. The updating of player value(s) may be performed as indicated in association with FIG. 3A above, in particular step 305A.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

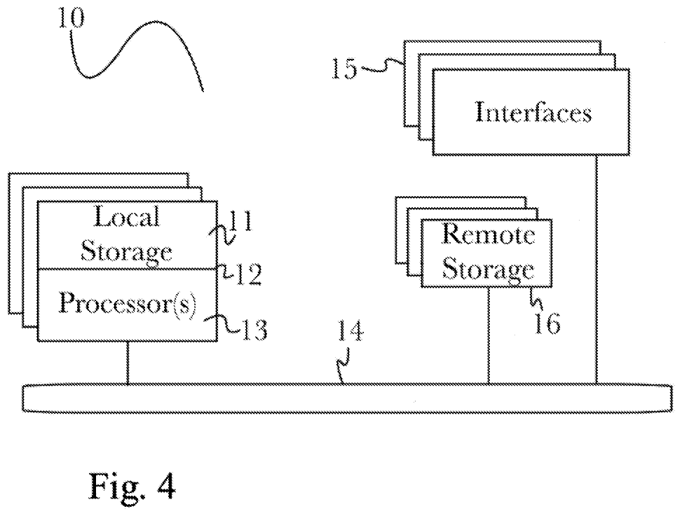

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments). Any of the above mentioned systems, units, modules, engines, controllers, components or the like may be and/or comprise hardware and/or software as described herein. For example, the player exchange engine 102 and subcomponents thereof may be and/or comprise computing hardware and/or software as described herein in association with FIGS. 4-7. Furthermore, any of the above mentioned systems, units, modules, engines, controllers, components, interfaces or the like may use and/or comprise an application programming interface (API) for communicating with other systems units, modules, engines, controllers, components, interfaces or the like for obtaining and/or providing data or information.

Referring now to FIG. 4, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one aspect, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one aspect, a computing device 10 may be configured or designed to function as a server system utilizing CPU 12, local memory 11 and/or remote memory 16, and interface(s) 15. In at least one aspect, CPU 12 may be caused to perform one or more of the different types of functions and/or operations under the control of software modules or components, which for example, may include an operating system and any appropriate applications software, drivers, and the like.

CPU 12 may include one or more processors 13 such as, for example, a processor from one of the Intel, ARM, Qualcomm, and AMD families of microprocessors. In some embodiments, processors 13 may include specially designed hardware such as application-specific integrated circuits (ASICs), electrically erasable programmable read-only memories (EEPROMs), field-programmable gate arrays (FPGAs), and so forth, for controlling operations of computing device 10. In a particular aspect, a local memory 11 (such as non-volatile random-access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one aspect, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 4 illustrates one specific architecture for a computing device 10 for implementing one or more of the embodiments described herein, it is by no means the only device architecture on which at least a portion of the features and techniques described herein may be implemented. For example, architectures having one or any number of processors 13 may be used, and such processors 13 may be present in a single device or distributed among any number of devices. In one aspect, single processor 13 handles communications as well as routing computations, while in other embodiments a separate dedicated communications processor may be provided. In various embodiments, different types of features or functionalities may be implemented in a system according to the aspect that includes a client device (such as a tablet device or smartphone running client software) and server systems (such as a server system described in more detail below).

Regardless of network device configuration, the system of an aspect may employ one or more memories or memory modules (such as, for example, remote memory block 16 and local memory 11) configured to store data, program instructions for the general-purpose network operations, or other information relating to the functionality of the embodiments described herein (or any combinations of the above). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a Java virtual machine or equivalent, or files containing higher level code that may be executed by the computer using an interpreter (for example, scripts written in Python, Perl, Ruby, Groovy, or any other scripting language).

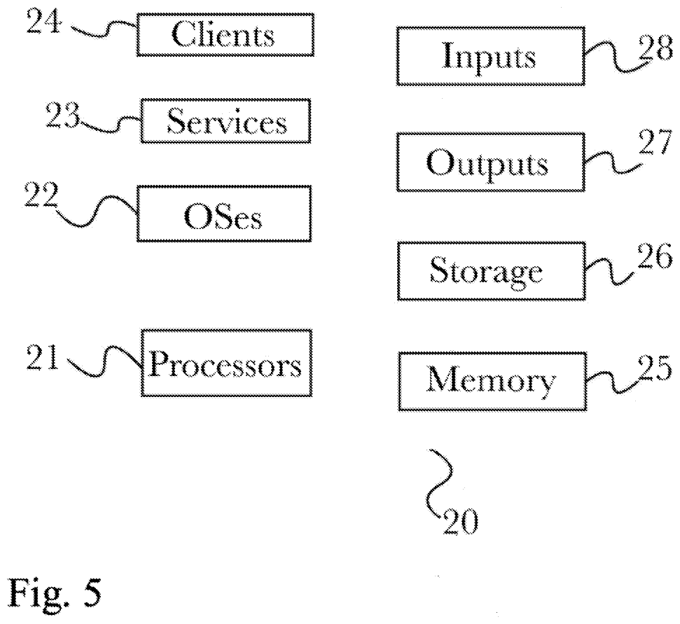

In some embodiments, systems may be implemented on a standalone computing system. Referring now to FIG. 5, there is shown a block diagram depicting a typical exemplary architecture of one or more embodiments or components thereof on a standalone computing system. Computing device 20 includes processors 21 that may run software that carry out one or more functions or applications of embodiments, such as for example a client application. Processors 21 may carry out computing instructions under control of an operating system 22 such as, for example, a version of MICROSOFT WINDOWS™ operating system, APPLE macOS™ or iOS™ operating systems, some variety of the Linux operating system, ANDROID™ operating system, or the like. In many cases, one or more shared services 23 may be operable in system 20, and may be useful for providing common services to client applications. Services 23 may for example be WINDOWS™ services, user-space common services in a Linux environment, or any other type of common service architecture used with operating system 21. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memristor, or electrical storage device for storage of data in digital form (such as those described above, referring to FIG. 4). Examples of storage devices 26 include flash memory, magnetic hard drive, CD-ROM, and/or the like.

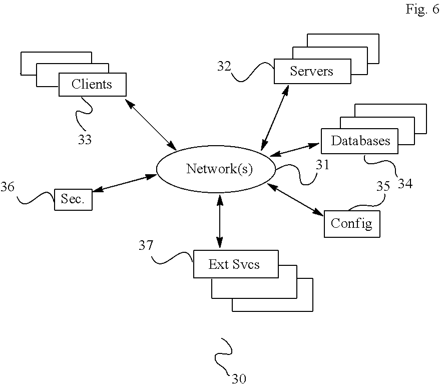

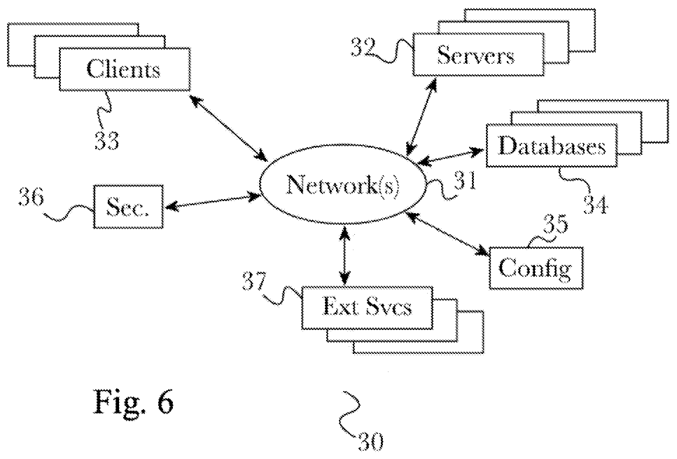

In some embodiments, systems may be implemented on a distributed computing network, such as one having any number of clients and/or servers. Referring now to FIG. 6, there is shown a block diagram depicting an exemplary architecture 30 for implementing at least a portion of a system according to one aspect on a distributed computing network. According to the aspect, any number of clients 33 may be provided. Each client 33 may run software for implementing client-side portions of a system; clients may comprise a system 20 such as that illustrated in FIG. 5. In addition, any number of servers 32 may be provided for handling requests received from one or more clients 33. Clients 33 and servers 32 may communicate with one another via one or more electronic networks 31, which may be in various embodiments any of the Internet, a wide area network, a mobile telephony network (such as CDMA or GSM cellular networks), a wireless network (such as WiFi, WiMAX, LTE, and so forth), or a local area network (or indeed any network topology known in the art; the aspect does not prefer any one network topology over any other). Networks 31 may be implemented using any known network protocols, including for example wired and/or wireless protocols.

In addition, in some embodiments, servers 32 may call external services 37 when needed to obtain additional information, or to refer to additional data concerning a particular call. Communications with external services 37 may take place, for example, via one or more networks 31. In various embodiments, external services 37 may comprise web-enabled services or functionality related to or installed on the hardware device itself. For example, in one aspect where client applications are implemented on a smartphone or other electronic device, client applications may obtain information stored in a server system 32 in the cloud or on an external service 37 deployed on one or more of a particular enterprise's or user's premises.

In some embodiments, clients 33 or servers 32 (or both) may make use of one or more specialized services or appliances that may be deployed locally or remotely across one or more networks 31. For example, one or more databases 34 may be used or referred to by one or more embodiments. It should be understood by one having ordinary skill in the art that databases 34 may be arranged in a wide variety of architectures and using a wide variety of data access and manipulation means. For example, in various embodiments one or more databases 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some embodiments, variant database architectures such as column-oriented databases, in-memory databases, clustered databases, distributed databases, or even flat file data repositories may be used according to the aspect. It will be appreciated by one having ordinary skill in the art that any combination of known or future database technologies may be used as appropriate, unless a specific database technology or a specific arrangement of components is specified for a particular aspect described herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, some embodiments may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments without limitation, unless a specific security 36 or configuration system 35 or approach is specifically required by the description of any specific aspect.

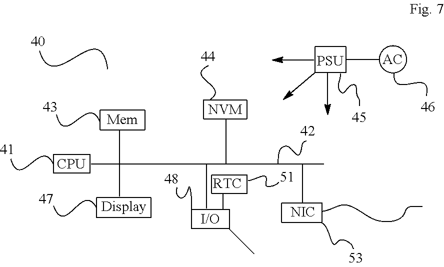

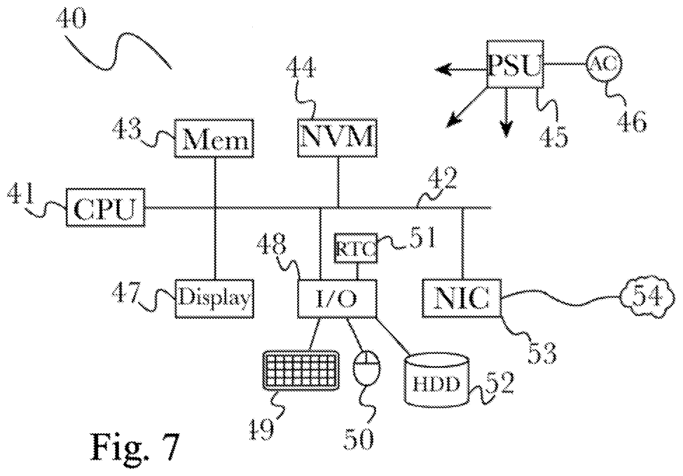

FIG. 7 shows an exemplary overview of a computer system 40 as may be used in any of the various locations throughout the system. It is exemplary of any computer that may execute code to process data. Various modifications and changes may be made to computer system 40 without departing from the broader scope of the system and method disclosed herein. Central processor unit (CPU) 41 is connected to bus 42, to which bus is also connected memory 43, nonvolatile memory 44, display 47, input/output (I/O) unit 48, and network interface card (NIC) 53. I/O unit 48 may, typically, be connected to keyboard 49, pointing device 50, hard disk 52, and real-time clock 51. NIC 53 connects to network 54, which may be the Internet or a local network, which local network may or may not have connections to the Internet. Also shown as part of system 40 is power supply unit 45 connected, in this example, to a main alternating current (AC) supply 46. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of various embodiments may be distributed among any number of client and/or server components. For example, various software modules may be implemented for performing various functions in connection with the system of any particular aspect, and such modules may be variously implemented to run on server and/or client components.

The skilled person will be aware of a range of possible modifications of the various embodiments described above. Accordingly, the present invention is defined by the claims and their equivalents.

### Additional Considerations

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and Bis false (or not present), A is false (or not present) and Bis true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and/or a process associated with the disclosed principles herein. Thus, while particular embodiments and applications have been illustrated and described, it is to be understood that the disclosed embodiments are not limited to the precise construction and components disclosed herein. Various apparent modifications, changes and variations may be made in the arrangement, operation and details of the method and apparatus disclosed herein without departing from the spirit and scope defined in the appended claims.

What is claimed is:

1. A computer implemented method for optimizing gameplay on an electronic social gaming platform, the optimization based on the number of active accounts on the electronic social gaming platform, and stage of gameplay, the computer implemented method comprising:
obtaining a first value for a game unit for a plurality of game units that are acquirable on the electronic social gaming platform;
updating the first value based on a value algorithm comprising the following variables: game unit ownership percentage, game unit past performance relative to past expected performance, and game unit projected performance;
changing a first weighting of variables in the value algorithm based on the number of active accounts on the electronic social gaming platform to generate a second value algorithm, wherein as the number of active accounts increases, the weighting of game unit ownership percentage is increased relative to the weighting of at least one of game unit past performance relative to past expected performance and game unit projected performance;
change a second weighting of variables in the second value algorithm based on the stage of gameplay on the electronic social gaming platform to generate a third value algorithm, wherein as the stage of gameplay progresses, the weighting of game unit ownership percentage is increased relative to the weighting of at least one of game unit past performance relative to past expected performance and game unit projected performance;
calculate a second value for the game unit by applying the third value algorithm;
enabling a user associated with an account to transact with a game unit based on the second value of the game unit;
enabling a user to play with a plurality of transacted game units with any plurality of other users within the electronic social gaming platform, regardless of whether the plurality of users are in a league with each other.

2. A computer implemented method for dynamically determining weights for an athlete valuation algorithm for fantasy sports to allow for adjustments in the valuation algorithm as a fantasy sport season progresses and the number of users registered on a fantasy sports platform changes over time, the computer implemented method comprising:
applying a weighting algorithm to assign an athlete value to each athlete in a database of acquirable athletes associated with a fantasy sport competition hosted on a fantasy sports platform, the weighting algorithm comprising a first weight based on athlete ownership percentage, a second weight based on athlete past performance, and a third weight based on athlete projected performance;
providing a plurality of registered users with remote access to the fantasy sports platform such that any user has access to the athlete values in real-time thereby enabling users to adjust a user roster by adding or removing an athlete via a roster change operation;
dynamically obtaining user registration information, the user registration information comprising a total number of users registered for a fantasy sport, the dynamically obtaining comprising obtaining up to date user registration information as user registration information changes over time;
obtaining season progress information comprising a measure of percent completion for a fantasy sport season;
dynamically updating at least the first weight based on the total number of registered users and the season progress information;
dynamically applying the weighting algorithm at threshold time intervals using the updated first weights to determine updated athlete values;
providing the updated athlete values to users in real-time such that subsequent roster change operations are based on the updated athlete values.
